(19) United States
(12) Patent Application Publication
(10) Pub. No.: US 2006/0225560 A1
(43) Pub. Date: Oct. 12, 2006

(54) Training system for a musical instrument

(76) Inventor: Paul Edward Sherman, Tecumseh, MI (US)

Correspondence Address: SCHOX PLC, 209 N. MAIN STREET #200, ANN ARBOR, MI, 48104, US

(21) Appl. No.: 11/103,823

(22) Filed: Apr. 12, 2005

(51) Int. Cl. G09B 15/00; G09B 15/04; G09B 15/02

(52) U.S. Cl. 84/470 R

(57) ABSTRACT

The system of the preferred embodiments includes a fastener adapted to removably attach to a musical instrument, a blind coupled to the fastener and adapted to obstruct a user's view of the finger portion of the musical instrument, and a joint to couple the fastener to the blind. The system of the preferred embodiment has been specifically designed to obstruct a user's view of the finger portion of the musical instrument. If used properly, the system will train a user of the musical instrument to play without looking at the finger portion of the musical instrument thus aiding in muscle memory and helping the sense of sound by minimizing the use of sight. Furthermore, the blind portion of the instrument can be used as a visual output/input screen for use as electronic sheet music, notes, and communication device to the conductor.

### TECHNICAL FIELD

This invention relates generally to the musical instrument field, and more specifically to an improved training system for playing a musical instrument having a finger portion defined by the area where the fingers of a user are placed to modulate sound.

### BACKGROUND

As a user is learning to play a musical instrument, they have a tendency, while playing, to watch their finger placement on the finger portion of the musical instrument. This is not desired. The user is meant to look up in order to develop muscle memory in the hands while “fishing for the note” and relying on sound to determine proper finger placement as opposed to sight. Additionally, it is distracting to an instructor to have a student focusing on the finger placement as opposed to other musicians, the sheet music and ultimately, the conductor. There is a need in the musical instrument field to create a training system that obstructs a user's view of the finger portion of the musical instrument in order to train the user to play without looking at the finger portion of the musical instrument.

### BRIEF DESCRIPTION OF THE FIGURES

FIGS. 1 and 2 are schematic drawings of the system of the preferred embodiment.

FIGS. 3 and 4 are schematic drawings of two variations of the fastener and the blind of the preferred embodiment.

FIGS. 5, 6, and 7 are schematic drawings of three of the variations of the blind of the preferred embodiment.

### DESCRIPTION OF THE PREFERRED EMBODIMENT

The following description of the preferred embodiment of the invention is not intended to limit the invention to this preferred embodiment, but rather to enable any person skilled in the art to make and use this invention.

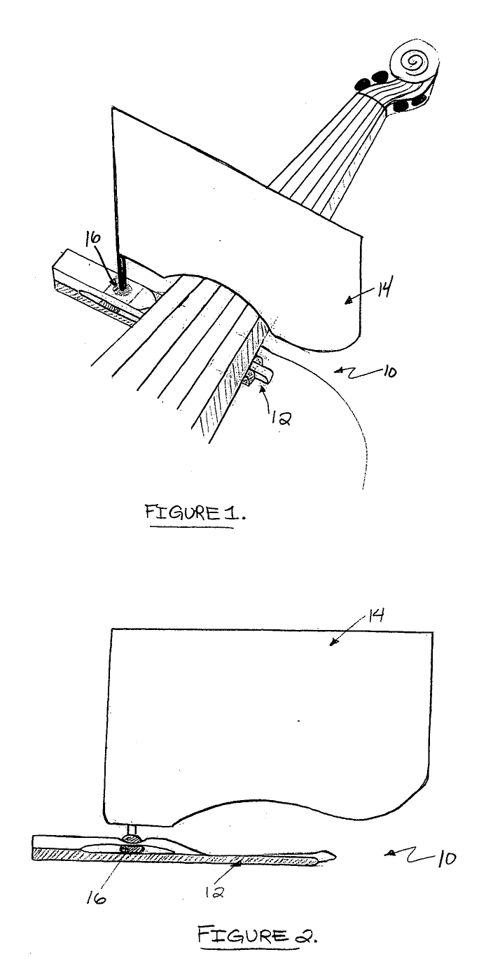

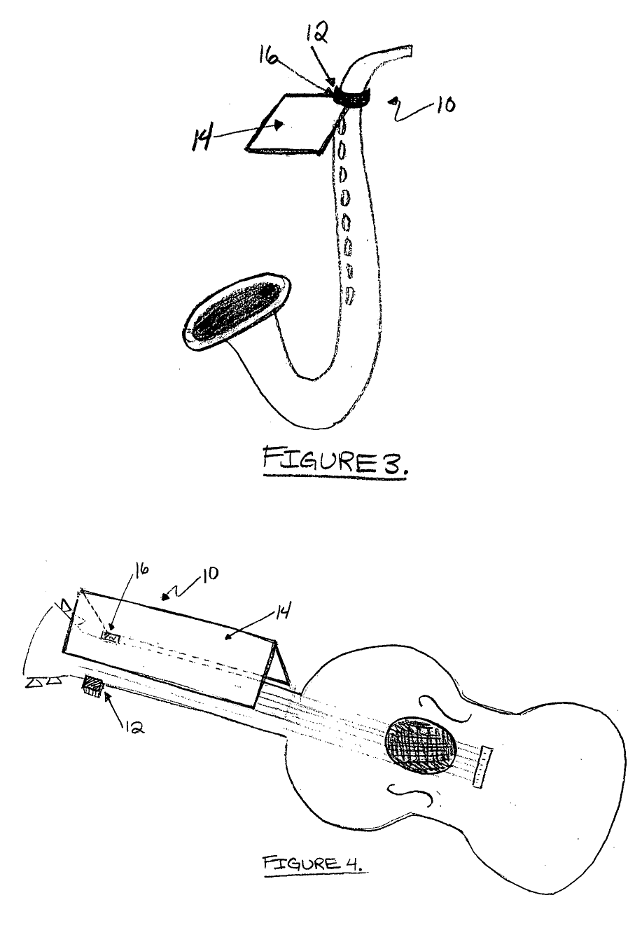

As shown in FIGS. 1 and 2 the system lo of the preferred embodiment includes a fastener 12 adapted to removably attach to a musical instrument, a blind 14 coupled to the fastener 12 and adapted to obstruct a user's view of the finger portion of the musical instrument, and a joint 16 to couple the fastener 12 to the blind 14. The system 10 of the preferred embodiment has been specifically designed to train a user of the musical instrument to play without. looking at the finger portion of the musical instrument. The system 10, however, may be used in any suitable environment and for any suitable reason.

The fastener 12 of the preferred embodiment functions to removably attach to the musical instrument. The fastener 12 is preferably adapted to be suitable for both left and right-handed musical instruments. In a first variation, the fastener 12 includes a member of compliant material. The member is preferably dimensioned larger than the crevice of the musical instrument. The crevice is preferably defined by a fingerboard and a belly of the musical instrument. The member, engaged with the crevice, preferably creates a frictional engagement, removably attaching the system 10 to the musical instrument. The compliant member of the fastener 12 is preferably made of rubber, but may alternatively be made of any suitable compliant material, such as plastic or wood, that will not damage the surface of the musical instrument.

In second variation, as shown in FIGS. 1 and 2, the fastener 12 includes a first member and a second member adapted to be biased in an opposing direction from the first member. The first and second members, engaged with the crevice, preferably create a frictional engagement, removably attaching the system 10 to the musical instrument. The first and second members of the fastener 12 are preferably made of rubber, but may alternatively be made of any suitable material, such as plastic or wood, that will not damage the surface of the musical instrument.

In a third and fourth variation, the fastener 12 further includes a connecting element adapted to provide a force on the first and second members of the fastener 12 in order to bias the first and second members in opposing directions. In the third variation, the connecting element of the fastener 12 is preferably a spring adapted to statically hold the first and second members apart. The first and second member, engaged with the crevice, preferably create a frictional engagement due to the spring force, removably attaching the system 10 to the musical instrument. In the fourth variation, the connecting element of the fastener 12 is a screw. The first and second members are engaged with the crevice and the screw is rotated, separating the first and second members against the sides of the crevice. This provides a frictional engagement, removably attaching the system 10 to the musical instrument. The connecting element is preferably a spring or a screw, but may alternatively be any suitable element that provides a force on the first and second members of the fastener 12 in order to bias the first and second members in opposing directions.

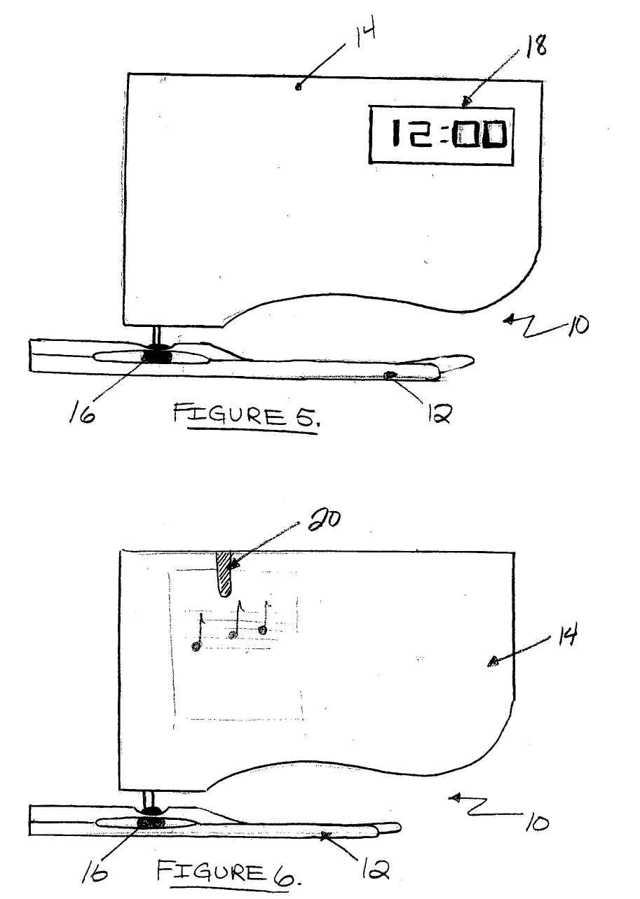

In a fifth and sixth variation, the fastener 12 includes a first member and a second member that are adapted to engage an elongated portion of the musical instrument with a clamping force. The clamping force can be generated with a spring or elastic member or by a cam action, screw or any other suitable means of achieving clamp force to the instrument thus affixing the fastener to the instrument. Alternately, the fastener may be a sticky medium (such as double-backed tape) that allows the blind to be attached to the instrument in order to minimize acoustical distortion created by the device. An elongated portion of the musical instrument is preferably defined by a fret board of a guitar, banjo, mandolin, ukulele, or any similar instrument; a fingerboard of a cello, double bass, or any standing string instrument; and a cylindrical portion of a brass or woodwind instrument. In the fifth variation, as shown in FIG. 3, the fastener 12 includes a first and second half circular member adapted to snap fit around the cylindrical portion of a brass or woodwind instrument in the appropriate position for the given instrument. In this variation, the first and second half circular members are preferably made of rubber or plastic, but may alternatively be made of any suitable material that will not damage the surface of the musical instrument. In a sixth variation, as shown in FIG. 4, the fastener 12 includes a first and second member adapted to be a clamp and to removably attach to the fret board of guitar, banjo, mandolin, ukulele, or any similar instrument. In this variation, the first and second members of the clamp are preferably made of rubber or plastic, but alternatively may be made of any suitable material that will not damage the surface of the musical instrument. Although the fastener 12 is preferably one of these six variations, the fastener 12 may be any suitable device or method to removably attach to the musical instrument.

The blind 14 of the preferred embodiment is coupled with the fastener 12 and functions to obstruct a user's view of the finger portion of the musical instrument. The blind 14 is suitably positioned with respect to the system 10 and the musical instrument as to obstruct a user's view of the finger portion of the musical instrument. The blind 14 is preferably rectangular and planar, but may alternatively be of any suitable shape to fit a given instrument and to adequately obstruct a user's view of the finger portion of the musical instrument. The blind may be perforated or translucent to allow a partially obstructed view of the finger placement by “screening” the finger placement. Alternately, the screening could be adjustable to vary the degree of visibility thus allowing the user to adjust the device according to skill level and preference. Furthermore, the screening can serve as a decorative element to embellish the beauty of the blind while serving to partially obstruct view. The blind 14 is preferably made of plastic or cardboard, but may alternatively be made of any suitable material to obstruct or partially obstruct a user's view of the finger portion of the musical instrument, such as metal, fabric, wood, or glass.

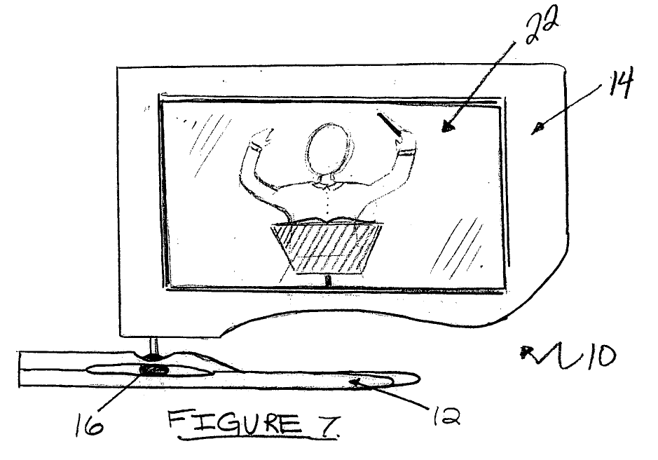

In a first variation, as shown in FIG. 4, the blind 14 is dimensioned such that the length dimension is similar to that of a fret board of a guitar, banjo, mandolin, ukulele, or any similar instrument so that it may obstruct a user's view of their finger placement along the length of the fret board. The blind 14 in this variation is preferably positioned over the length of the fret board in order to obstruct a user's view of the fret board, which is held down, near their lap rather than at their shoulder where a violin or viola is held. In a second variation, as shown in FIGS. 5 and 6, the blind 14 further includes an accessory selected from the group including a clock 18, a metronome, tuning device, and a clip 20. The clip 20 may be used to hold sheet music, photos, or any suitable materials.

In a third variation, the blind 14 is selectively transparent. In this variation the blind 14 may further include a microchip configured to detect the portion of the song that the user is playing. If the particular portion of the song is preprogrammed (or if determined in real-time) to be difficult, then the microchip may control the blind to become transparent for a time period. The blind 14 may preferably utilize a technology similar to Electrochromic Windows, but may alternatively utilize any suitable technology to become transparent during the segments of greater difficulty.

In a fourth variation, as shown in FIG. 7, the blind 14 further includes a visual output device 22 preferably adapted to display training aids, but may alternatively be adapted to display any other suitable images. The visual output device 22 is preferably a digital screen, such as an LCD screen, buy may alternatively be any suitable visual output device adapted to display training aids and other suitable images. The training aids may include, but are not limited to, a video image of the correct finger positions on the finger portion of the musical instrument, a digital image of sheet music corresponding to the song and the current position of the user playing the song, and a video image of the conductor. The training aids may be adjusted according to the level of the player, the environment, and the instrument.

In a fifth variation, the blind 14 may also include a wireless device. The wireless device may function to remotely connect the blind 14 with the user, the conductor, and the instructor. The wireless device may also function to connect the blind 14 to a larger network, such as a ZigBee network, a Bluetooth network, or an Internet-protocol based network. The wireless device is preferably utilized by the user, the conductor, or the instructor to signal the blind to become selectively transparent or to display various training aids, but may alternatively be utilized in any suitable manner. Although the blind 14 is preferably one of these five variations, the blind 14 may be any suitable device or method to obstruct a user's view of the finger portion of the musical instrument.

The joint 16 of the preferred embodiment functions to couple the fastener 12 to the blind 14. In a first variation, as shown in FIGS. 1 and 2, the joint 16 includes a ball joint and is adapted to preferably permit the blind 14 to swivel thus allowing the instructor to momentarily rotate the blind to a position that allows the student to view finger placement unobstructed, as necessary to help with difficult sections of music when vision may be required momentarily. Upon engaging the fastener 12 with the crevice of the musical instrument, the frictional engagement of the first and second members of the fastener 12 on the ball joint preferably secures the blind 14 into the desired position. The joint 16 in this variation is preferably made of plastic or wood, but may alternatively be made of any suitable material.

In a second, third, and fourth variation the joint 16 includes a fixed connection point between the fastener 12 and the blind 14. In the second variation the joint 16 includes a fused connection. The fused point is preferably a weld, but may alternatively be any fused connection between the fastener 12 and the blind 14. In the third variation the joint 16 includes a male/female connection between the blind 14, which is adapted to screw into or snap into the fastener 12, and the fastener 12, which is adapted to receive the snap or screw of the blind 14. This variation preferably permits different fasteners 12 and different blinds 14, suitable for various instruments and various users, to be exchanged in and out of the system 10. In the fourth variation the joint 16 includes a clamp. The clamp is adapted to engage both the fastener 12 and the blind 14 and is preferably made of plastic or rubber, but may alternatively be made of any suitable material. This variation also preferably permits different fasteners 12 and different blinds 14, suitable for various instruments and various users, to be exchanged in and out of the system 10. Although the joint 16 is preferably one of these four variations, the joint 16 may be any suitable device or method to couple the fastener 12 to the blind 14.

As a person skilled in the art will recognize from the previous detailed description and from the figures and claims, modifications and changes can be made to the preferred embodiment and variations of the invention without departing from the scope of this invention defined in the following claims.

I claim:

1. A training system for a musical instrument having a finger portion defined by the area where the fingers of a user are placed to modulate sound, comprising:
a fastener adapted to removably attach to the musical instrument;
a blind coupled to the fastener and adapted to obstruct a user's view of the finger portion of the musical instrument; and
a joint coupling the fastener to the blind.

2. The system of claim 1 wherein the fastener is adapted to be suitable for both left and right-handed musical instruments.

3. The system of claim 1, wherein the fastener is made of a sticky medium and is adapted to adhere to the instrument.

4. The system of claim 1 wherein the fastener includes a first member adapted to create a first frictional engagement with the musical instrument.

5. The system of claim 4 wherein the first member is made of compliant material adapted to create a frictional engagement with a crevice of the musical instrument.

6. The system of claim 5 wherein the fastener further includes a second member adapted to create a second frictional engagement with the musical instrument.

7. The system of claim 6 wherein the fastener further includes a connecting element adapted to provide a force in order to bias the second member away from the first member.

8. The system of claim 7 wherein the first and second members are adapted to frictionally engage a crevice defined by a fingerboard and a belly of the musical instrument.

9. The system of claim 6 wherein the fastener further includes a connecting element adapted to provide a force in order to bias the second member toward from the first member.

10. The system of claim 9 wherein the first and second members are adapted to frictionally engage an elongated portion of the musical instrument.

11. The system of claim 1 wherein the blind is adapted to extend along the length of a fret board of a stringed guitar.

12. The system of claim 1 wherein the blind includes a clip.

13. The system of claim 1 wherein the blind includes an accessory selected from the group including a metronome and a clock.

14. The system of claim 1 wherein the blind is adapted to become selectively transparent.

15. The system of claim 1 wherein the blind further includes a visual output device adapted to display training aids and other suitable images.

16. The system of claim 1 wherein the joint includes a ball joint and is adapted to permit that the blind to swivel while the system is detached from the musical instrument, and is further adapted to fix the blind in a position while the system is attached to the musical instrument.

17. The system of claim 1 wherein the joint further includes a clamp adapted to engage both the fastener and the blind.
